(19) United States
(12) Patent Application Publication
(10) Pub. No.: US 2023/0166758 A1
(43) Pub. Date: Jun. 1, 2023

(54) SENSOR CALIBRATION DURING TRANSPORT

(71) Applicant: GM Cruise Holdings LLC, San Francisco, CA (US)

(72) Inventor: Jeffrey Brandon, Phoenix, AZ (US)

(73) Assignee: GM Cruise Holdings LLC, San Francisco, CA (US)

(21) Appl. No.: 17/538,168

(22) Filed: Nov. 30, 2021

(51) Int. Cl. B60W 60/00; G06V 20/56; G06T 7/80

(52) U.S. Cl. CPC B60W 60/00; G06V 20/56; G06T 7/80; B60W 2050/0083

(57) ABSTRACT

Systems and methods are provided for calibrating vehicle sensors while a vehicle is being transported from one location to another. In particular, instead of using a dedicated calibration facility, systems and methods are provided for using mapped features to perform extrinsic sensor calibration while transporting the vehicle on an open-bed truck, train, or other open-bed vehicle hauler. During transport, a known distance between the vehicle sensor and a mapped target is determined, and compared to a measured distance between the vehicle sensor and the mapped target. The vehicle sensor is calibrated based on the comparison.

### FIELD OF THE DISCLOSURE

The present disclosure relates generally to vehicle sensors and to systems and methods for calibrating vehicle sensors.

### BACKGROUND

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. The vehicles can also be used to pick up packages and/or other goods and deliver the packages and/or goods to selected destinations.

Autonomous vehicles sensors are calibrated prior to autonomous vehicles operating autonomously. Generally, calibration takes place in a dedicated facility with targets positioned at known locations relative to the vehicle position. In some instances, vehicle sensors are recalibrated, either periodically or following an event. However, sensor calibration can be resource intensive as well as time consuming.

### SUMMARY

Systems and methods are provided for calibrating vehicle sensors while a vehicle is being transported from one location to another. In particular, systems and methods are provided for using mapped features to perform extrinsic sensor calibration while transporting the vehicle on an open-bed truck, train, or other open-bed vehicle hauler.

According to one aspect, a method for calibrating vehicle sensors during transport, comprises determining, during transport of a vehicle having a vehicle sensor on an open-bed hauler, a known distance between a vehicle sensor and a mapped target; measuring, using the vehicle sensor, a measured distance between the vehicle sensor and the mapped target; comparing the measured distance to the known distance to generate a distance comparison; and calibrating the vehicle sensor based on the distance comparison.

In some implementations, the method further comprises placing a vehicle having a vehicle sensor on an open-bed hauler for transport. In some implementations, the method further comprises communicating calibration status with a central computing system. In some implementations, the method further comprises determining a vehicle sensor location using vehicle GPS. In some implementations, determining the known distance comprises using a mapped target location and the vehicle sensor location. In some implementations, the method further comprises determining a known angle between the vehicle sensor and the mapped target; and measuring, using the vehicle sensor, a measured angle between the vehicle sensor and the mapped target. In some implementations, the method further comprises comparing the measured angle to the known angle to generate an angle comparison, and calibrating the vehicle sensor based on the angle comparison.

In some implementations, placing the vehicle on the open-bed hauler for transport comprises placing the vehicle on one of a flatbed truck and a flatbed train carriage. In some implementations, the mapped target is one of a building, a billboard, a road sign, a street light, and a traffic light.

According to another aspect, a system for autonomous vehicle sensor calibration during transport, comprises an open-bed hauler for carrying an autonomous vehicle; an autonomous vehicle comprising: a sensor system including at least one vehicle sensor; a memory storing a map including mapped features and mapped feature locations; and a processor configured to: determine, during transport, a known distance between the at least one vehicle sensor and a mapped feature; measure, using the at least one vehicle sensor, a measured distance between the at least one vehicle sensor at the mapped feature; compare the measured distance to the known distance to generate a distance comparison; and calibrate the at least one vehicle sensor based on the distance comparison.

In some implementations, the autonomous vehicle includes a GPS system configured to determine a vehicle sensor location for the at least one vehicle sensor. In some implementations, the processor is further configured to determine the known distance using a mapped feature location and the vehicle sensor location. In some implementations, the processor is further configured to: determine a known angle between the vehicle sensor and the mapped feature; and measure, using the vehicle sensor, a measured angle between the vehicle sensor and the mapped feature. In some implementations, the processor is further configured to compare the measured angle to the known angle to generate an angle comparison, and calibrate the vehicle sensor based on the angle comparison.

In some implementations, the open-bed hauler is one of a flatbed truck and a flatbed train carriage. In some implementations, the mapped feature is one of a building, a billboard, a road sign, a street light, and a traffic light. In some implementations, the system further comprises a central computing system, and wherein the processor is further configured to communicate calibration status with the central computing system.

According to another aspect, a system for autonomous vehicle sensor calibration during transport, comprises an open-bed hauler for carrying an autonomous vehicle; a central computing system comprising: a memory configured to store a map including mapped features and mapped feature locations; and an autonomous vehicle comprising: a sensor system including a vehicle sensor; a processor configured to: communicate with the central computing system to receive mapped feature locations; determine, during transport, a known distance between the at least one vehicle sensor and a respective mapped feature location; measure, using the at least one vehicle sensor, a measured distance between the at least one vehicle sensor at the mapped feature location; compare the measured distance to the known distance to generate a distance comparison; and calibrate the at least one vehicle sensor based on the distance comparison.

In some implementations, the processor is further configured to communicate a calibration status with the central computing system. In some implementations, the autonomous vehicle includes a global positioning system (GPS) configured to determine a vehicle sensor location for the vehicle sensor. In some implementations, the autonomous vehicle includes a global positioning system (GPS) configured to determine an autonomous vehicle location, and wherein a vehicle sensor location for the vehicle sensor is determined based on the autonomous vehicle location. In some implementations, the autonomous vehicle includes an inertial measurement unit (IMU) configured to determine an autonomous vehicle location. In some implementations, the open-bed hauler is one of a flatbed truck and a flatbed train carriage.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a diagram illustrating an autonomous vehicle, according to some embodiments of the disclosure;

FIG. 2 is a flow chart illustrating a method for autonomous vehicle sensor calibration during vehicle transport on an open-bed vehicle hauler, according to some embodiments of the disclosure;

FIG. 3 is a diagram illustrating a vehicle on a flatbed hauler for transport, according to various embodiments of the disclosure;

FIG. 4 is a diagram illustrating two vehicles on a flatbed hauler 404 for transport, according to various embodiments of the disclosure;

FIG. 5 is a diagram illustrating an autonomous vehicle on a flatbed truck for sensor calibration during transport, according to various embodiments of the disclosure;

FIG. 6 is a diagram illustrating a fleet of autonomous vehicles in communication with a central computer, according to some embodiments of the disclosure; and

FIG. 7 shows an example embodiment of a system for implementing certain aspects of the present technology.

### DETAILED DESCRIPTION

### Overview

Systems and methods are provided for calibrating vehicle sensors while a vehicle is being transported from one location to another. In particular, systems and methods are provided for using mapped features to perform extrinsic sensor calibration while transporting the vehicle on an open-bed truck, train, or other open-bed vehicle hauler.

Sensor calibration is an integral part of autonomous vehicle operation on the road. In general, there are two categories of calibration: intrinsic calibration and extrinsic calibration. Intrinsic calibration relates to internal sensor parameters (e.g., lens distortion coefficients, beam angles for LIDARs, etc.), and is typically done at the component supplier or within the vehicle assembly plant prior to sensor installation. Intrinsic calibrations are fairly stable throughout the life of the sensor. Extrinsic calibration corrects for variation resulting from sensor mounting tolerance. Extrinsic calibration is performed after sensor installation in the vehicle, prior to operation of the vehicle. Extrinsic calibrations are not stable through the life of an autonomous vehicle. Extrinsic calibration may be repeated periodically, and it may be repeated after events that can result in sensor irregularities, as well as after sensor replacement.

Extrinsic calibration is typically performed in a large facility space to fully calibrate the system. In particular, a large space is used in order to calibrate long-range sensors. In some examples, physical targets are placed at a fixed distance from a vehicle and the sensor is evaluated to see if it accurately determines target location as a vehicle is rotated. However, in some areas, such as cities, it can be difficult to find a large open facility suitable for calibration. Additionally, the cost of a large facility can be prohibitive. Furthermore, the time allotted for calibration results in additional downtime for an autonomous vehicle before it can be put into operation. Enabling calibration to be performed during transit takes advantage of this downtime and eliminates additional calibration downtime before and/or after the vehicle is transported to the operational city.

Alternative extrinsic calibration systems and methods are provided herein, in which calibration can be performed without a dedicated calibration facility. In particular, in some examples, previously mapped features can be used to perform extrinsic calibrations while a vehicle is being transported. In some examples, extrinsic calibrations can be performed while a vehicle is being transported from a manufacturing plant to a destination. In some examples, extrinsic calibrations can be performed while a vehicle is being transported to a fleet operational center prior to the first launch of the vehicle.

### Example Autonomous Vehicle Configured for Calibration During Transport

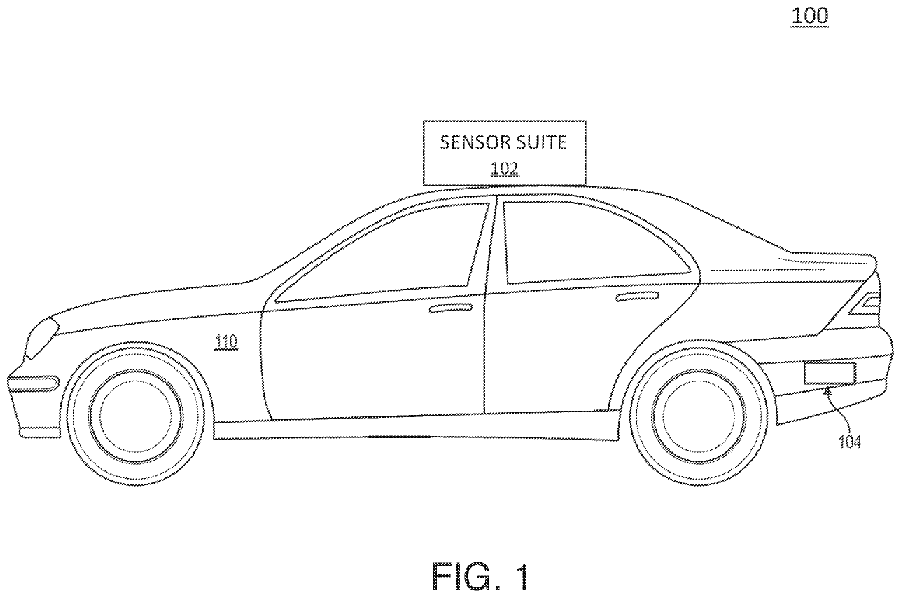

FIG. 1 is a diagram 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, and to sense and avoid obstacles. In various examples, the autonomous vehicle 110 includes multiple integrated surface transducers for detecting impacts and collisions. According to various implementations, the autonomous vehicle 110 is part of a fleet of vehicles for picking up passengers and/or packages and driving to selected destinations.

The sensor suite 102 includes localization and driving sensors. For example, the sensor suite may include one or more of photodetectors, cameras, RADAR, SONAR, LIDAR, GPS, inertial measurement units (IMUs), accelerometers, microphones, strain gauges, pressure monitors, barometers, thermometers, altimeters, wheel speed sensors, infrared sensors, thermal imaging sensors, and a computer vision system. Various sensors in the sensor suite 102 are calibrated before the autonomous vehicle 110 begins autonomous operational activity. In particular, extrinsic calibration of sensors in the sensor suite 102 is performed to ensure sensor measurement accuracy. The sensor suite 102 continuously monitors the autonomous vehicle's environment and, in some examples, sensor suite 102 data is used to detect selected events, and update a high fidelity map. In particular, data from the sensor suite can be used to update a map with information used to develop layers with waypoints identifying selected events, the locations of the encountered events, and the frequency with which the events are encountered at the identified location. In some examples, the events include road hazard data such as locations of potholes or debris. In some examples, data from the sensor suite can be used to update a map with information used to develop layers with selected calibration target information, where calibration targets can include buildings, signs, and other targets with a known position. In this way, sensor suite 102 data from many autonomous vehicles can continually provide feedback to the mapping system and the high fidelity map can be updated as more and more information is gathered.

The sensor suite 102 includes a plurality of sensors and is coupled to the onboard computer 104. In some examples, the onboard computer 104 receives data captured by the sensor suite 102 and utilizes the data received from the sensor suite 102 in controlling operation of the autonomous vehicle 110. In some examples, the onboard computer 104 combines data received from the sensor suite 102 with data received from multiple surface sensors to detect surface impacts and collisions. In some examples, one or more sensors in the sensor suite 102 are coupled to the vehicle batteries, and capture information regarding a state of charge of the batteries and/or a state of health of the batteries.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view. Autonomous vehicles typically utilize several sensors, such as LIDAR, camera, IMU, and high precision GPS, together with a high definition map to achieve centimeter-level accuracy of positioning and navigation. In some examples, the sensor suite 102 records information relevant to vehicle structural health. In various examples, additional sensors are positioned within the vehicle, and on other surfaces on the vehicle. In some examples, additional sensors are positioned on the vehicle chassis.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface) and/or other interested parties (e.g., via a vehicle coordinator or a remote expert interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

### Example Method for Calibration During Transport

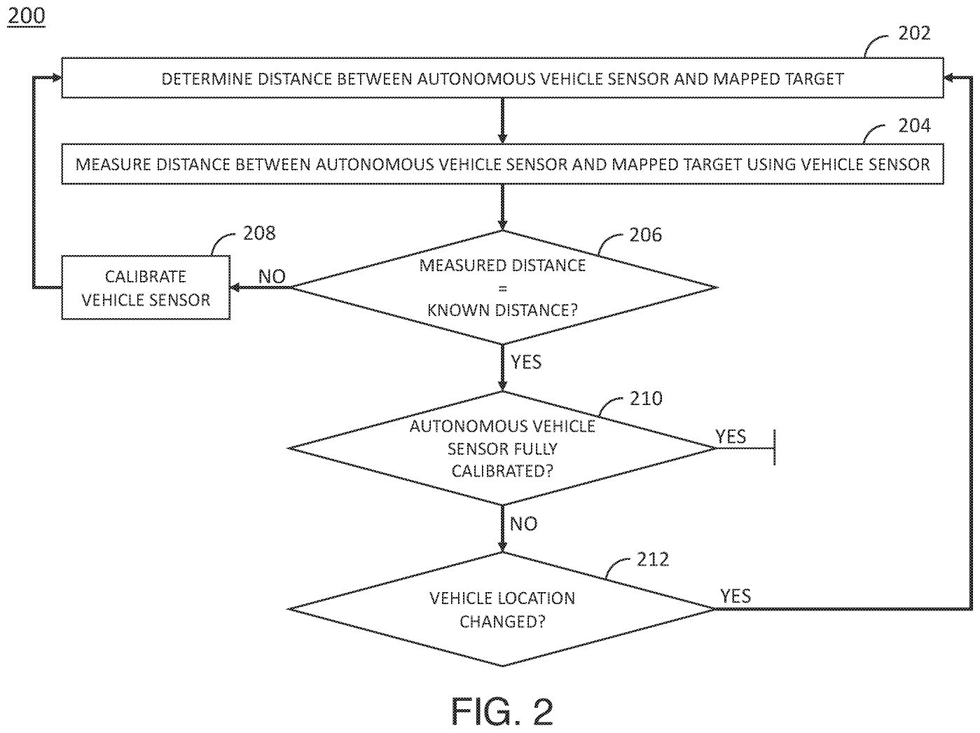

FIG. 2 is a flow chart illustrating a method 200 for autonomous vehicle sensor calibration during vehicle transport on an open-bed vehicle hauler, according to some embodiments of the disclosure. In particular, the method 200 is a method for extrinsic sensor calibration. Extrinsic calibration corrects for variation resulting from sensor mounting tolerance and can be performed periodically and/or after certain events. Some examples of events following which recalibration of the sensor suite may be performed include people hanging from sensor arms, people jumping on the autonomous vehicle, and people otherwise doing things to the autonomous vehicle. In some examples, component failure or damage can occur during operation, and the method 200 can be used for sensor recalibration. In some examples, when a vehicle has shut down, upon start up, sensor calibration is checked to ensure sensors have not been tampered with. If sensors are found to be out of calibration, the vehicle can be placed on an open vehicle hauler such as a flatbed truck, and the method 200 can be used to recalibrate the sensors.

At step 202, the distance between an autonomous vehicle sensor and a mapped feature target is determined. In particular, the distance determined at step 202 is a known distance. The target is a fixed object with an exact known location that does not change. Examples of targets include buildings, signs, billboards, street lights, and traffic lights. The target can be included as a feature on a map used for calibration.

Autonomous vehicles typically utilize several sensors, such as LIDAR, camera, IMU, and high precision GPS, together with a high definition map to achieve centimeter-level accuracy of positioning and navigation. In some examples, the autonomous vehicle sensor location is determined using GPS and/or IMU (Inertial Measurement Unit) data. GPS and IMU location measurements for known position of a vehicle are accurate within about an inch or less.

In other examples, the autonomous vehicle is being transported on another vehicle (e.g., a flatbed truck, a flatbed train carriage), and the transporting vehicle includes calibrated sensors that can be used to determine its location with respect to the mapped target. Then, the transporting vehicle location can be used to determine the autonomous vehicle location and the autonomous vehicle sensor location.

At step 204, the autonomous vehicle sensor is used to measure the distance between the mapped target and the autonomous vehicle sensor. At step 206, the distance measured by the autonomous vehicle sensor (the measured distance) is compared to the known distance determined at step 202. If the measured distance does not equal the known distance, then, at step 208, the autonomous vehicle sensor is calibrated and the method 200 returns to step 202. If the measured distance equals the known distance, then the autonomous vehicle sensor is accurately calibrated for that particular measurement and no additional calibration is needed at the known distance. In some examples, sensor position angles are calibrated. For example, an angle between the mapped target and the autonomous vehicle sensor can be measured and compared to a known angle between the mapped target and the autonomous vehicle sensor. In various examples, sensor-to-sensor calibration can be performed, such that individual sensors determine their place in the sensor system (or autonomous vehicle system) relative to other sensors. In some examples, camera-to-camera calibration is performed, to match pixels from one camera image together with pixels from another camera image and stitch images together.

Additional measurements at different distances can be performed to ensure accurate calibration of the autonomous vehicle sensor. At step 210, it is determined whether the autonomous vehicle sensor is fully calibrated. At step 210, if the autonomous vehicle sensor is fully calibrated, the method 200 ends. Note that when the method 200 ends at step 210, the autonomous vehicle can continue to monitor its sensors using routine checks. In some examples, an autonomous vehicle sensor is considered fully calibrated when accurate measurements have been taken at a selected set of distances. In various examples, the autonomous vehicle system communicates calibration status information with a central computing system. In some examples, remaining calibration items are communicated to the central computing system and the central computing system provides guidance regarding locations to exercise the remaining calibrations. In some examples, the autonomous vehicle receives feedback from the central computing system indicating when calibration is complete. According to various examples, once calibration is complete, the autonomous vehicle can be taken to (or returned to) the operational facility and prepared for autonomous operations.

At step 210, if the autonomous vehicle sensor is not fully calibrated, the method proceeds to step 212, and determines if the vehicle location has changed. If the location has changed, the method 200 returns to step 202 and the distance between the autonomous vehicle sensor and a mapped target is determined. Note that when the method 200 is repeated, the mapped target can be a different mapped target. If the vehicle location has not changed at step 212, the method 200 periodically checks for a location change at step 212 to continue calibration. In some examples, the method 200 is a method for calibrating a single sensor. In some implementations, multiple sensors are calibrated simultaneously. Thus, when one sensor is calibrated at a selected distance, another sensor can continue calibration operations at the selected distance. In various examples, the autonomous vehicle completes calibration when its various sensors are calibrated.

The method 200 is a method for extrinsic calibration. In various examples, perception and localization rely on precise sensor poses and positions on the autonomous vehicle, and the precise sensor poses and positions are determined via extrinsic calibration. In some examples, ground truth labeling and model training for perception entails high accuracy calibration. In particular, the level of accuracy is much tighter than typical automotive assembly or sensor manufacturing tolerances. For example, sensor system cameras mounted on top of an autonomous vehicle can be mounted with a three degree rotational variation from one car to the next, but camera-LIDAR extrinsic calibration is accurate to within less than 0.1 degrees. The method 200 is a method for high accuracy extrinsic calibration, for example for camera-LIDAR calibration accurate to less than 0.1 degree, that can be performed outside of a vehicle calibration facility.

In some examples, extrinsic calibration during transport is performed in addition to (or in combination with) calibrations at a facility. In various examples, some calibrations are performed during transport and others are performed in a facility. Performing some calibrations during transport can reduce the time it takes to finalize calibrations at a facility. In some examples, sensors calibrated during transport can include cameras, lidars, radars, and inertial measurement units (IMUs).

### Example Vehicle Calibration During Transport

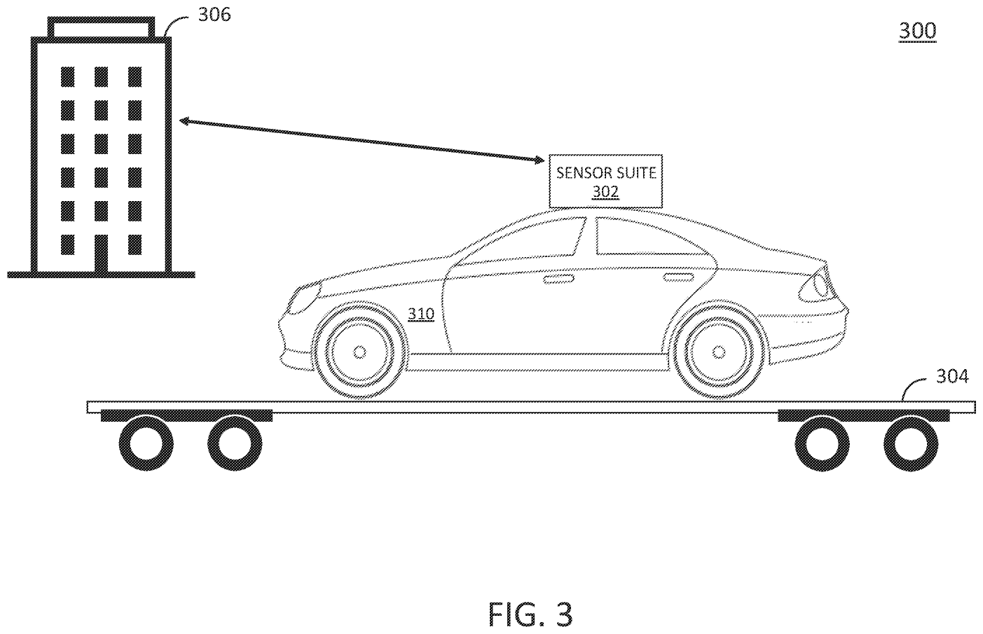

FIG. 3 is a diagram illustrating a vehicle 310 on a flatbed hauler 304 for transport, according to various embodiments of the disclosure. In some examples, the vehicle is on the flatbed of a truck. In other examples, the vehicle is on the flatbed carriage of a train. In other examples, the vehicle 310 is transported on another type of open car hauler. In various examples, the vehicle 310 is being transported from a manufacturing plant to a fleet operational center prior to vehicle launch. In some examples, the vehicle 310 is being transported following sensor failure, sensor damage, and/or sensor replacement. For example, in the operational city, after a collision, vandalism, or sensor replacement, the vehicle 310 can be placed on a flatbed truck for sensor calibration using mapped features such as buildings, signs, and street lights. The flatbed truck can drive around the operational city and the vehicle sensors can be calibrated while the vehicle is moved around on the flatbed truck, eliminating the space requirement of a calibration facility in or near the operational city for extrinsic calibration. In some examples, a selected corridor and/or route including various previously mapped features can be used for vehicle sensor calibration.

The diagram shows a building 306, which the sensor suite 302 of the vehicle 310 is using for calibration. In particular, a sensor in the sensor suite 302 that is being calibrated, measures the distance to the building 306. In some examples, the sensor measures the distance to a selected spot or selected location on the building 306. The sensor measurement is then compared to a known distance between the sensor and the selected location on the building 306, such that the accuracy of the sensor measurement can be evaluated, and the sensor can be calibrated.

There are several methods for determining the known distance. In some examples, the sensor suite GPS location can be used to determine autonomous vehicle 310 location and the exact location of the sensor being calibrated. This GPS-determined sensor location and the known building location can be used to determine the known distance. In some examples, a calibrated sensor on the flatbed 304 is used to determine a distance to the building 306. The location of the autonomous vehicle 310 on the flatbed 304 is also known, and thus the distance between the autonomous vehicle sensor and flatbed 304 calibrated sensor is known. Using these two known distances, the known distance between the autonomous vehicle sensor and the building 306 location can be determined.

As discussed above with respect to FIG. 2, in various implementations, the autonomous vehicle 310 communicates calibration information with a central computing system, which can provide feedback to the autonomous vehicle 310. In some examples, the autonomous vehicle 310 can inform the central computing system when calibration is complete, and the central computing system can route the flatbed hauler back to an operational facility to prepare the autonomous vehicle 310 for autonomous operations. In some examples, the autonomous vehicle 310 communicates remaining calibration items to the central computing system, and the central computing system can guide the flatbed hauler to selected locations and/or corridors for completion of the remaining calibrations.

Note that in various examples, different mapped features can be used. For example, road signs, street lights, traffic lights, and other stationary landmarks can be used for calibration. In some examples, calibration targets can be positioned on selected stationary landmarks. In some examples, calibration sensors can be embedded in stationary landmarks to determine known distances and confirm calibration.

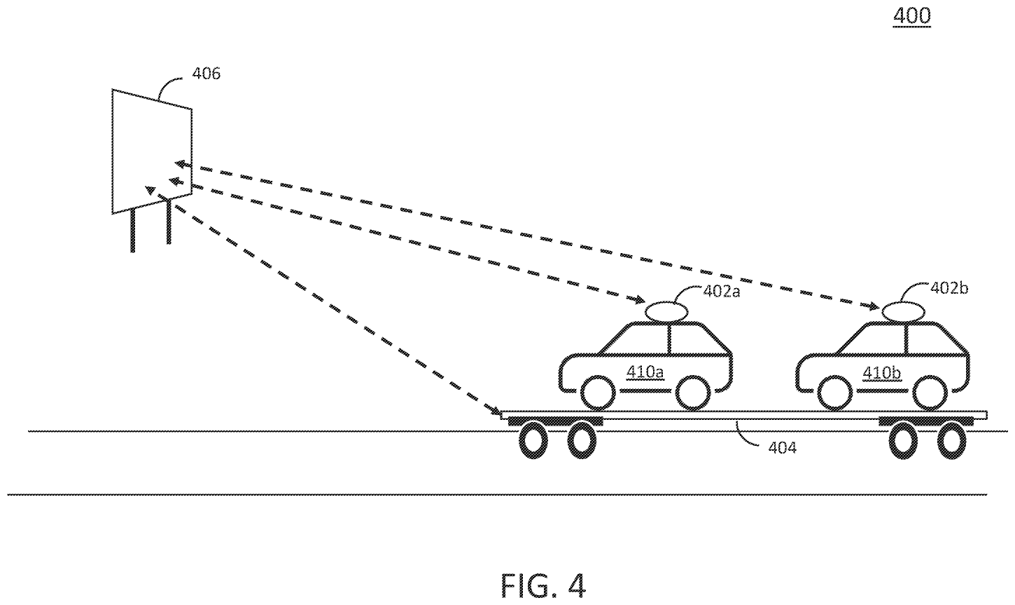

FIG. 4 is a diagram illustrating two vehicles 410a, 410b on a flatbed hauler 404 for transport, according to various embodiments of the disclosure. The vehicles 410a, 410b each include a respective sensor suite 402a, 402b. Sensors in the sensor suites 402a, 402b, as well as other sensors on the vehicles 410a, 410b, can be calibrated while the vehicles 410a, 410b are being transported on the flatbed hauler 404. In particular, mapped features along a transportation route can be used as calibration targets during transport. As shown in FIG. 4, a billboard 406 can be used as a mapped feature calibration target. In various examples, more than two vehicles can be transported on a flatbed hauler. In some examples, the hauler is an open vehicle hauler that is not a flatbed.

As discussed above with respect to FIG. 3, in some examples, the vehicles 410a, 410b are being transported from a manufacturing plant to a fleet operational center prior to vehicle launch. In some examples, the vehicles 410a, 410b are being transported in the operational city, for instance after a collision, vandalism, or sensor replacement, and the vehicles 410a, 410b are placed on a flatbed truck for sensor calibration within the operational city using mapped features such as signs, buildings, and street lights. This eliminates the space requirement of a calibration facility for extrinsic calibration within the operational city.

The diagram 400 shows a billboard 406, which the sensor suites 402a, 402b of the vehicles 410a, 410b use for calibration. In particular, one or more sensors that are being calibrated in each of the sensor suites 402a, 402b measures the distance and/or to the billboard 406. In some examples, the sensors measure the distance to a selected spot or selected location on the billboard. For example, the sensors can focus on the distance and/or angle to a selected corner of the billboard. In other examples, a specific target can be positioned on the billboard 406 and the sensor can focus on the target. In particular, a selected calibration target can be positioned on the billboard 406.

The sensor measurements are compared to a known distance between each of the sensors and the selected location on the billboard 406, such that the accuracy of the sensor measurements can be evaluated, and the sensors can be calibrated. One method for determining the known distance is to use a sensor suite 402a, 402b GPS location for each autonomous vehicle 410a, 410b, thereby determining a fairly accurate location of the sensor being calibrated. In particular, the GPS-determined sensor location and the known billboard 406 target location can be used to determine the known distance. In some examples, a calibrated sensor on the flatbed vehicle 404 is used to determine a distance to the billboard 406. The location of the autonomous vehicles 410a, 410b on the flatbed vehicle 404 is also known, and thus the distance between the autonomous vehicle 410a, 410b sensors and flatbed vehicle 404 calibrated sensor is known. Using these two known distances, the known distance between the autonomous vehicle 410a, 410b sensor and the billboard 406 target location can be determined.

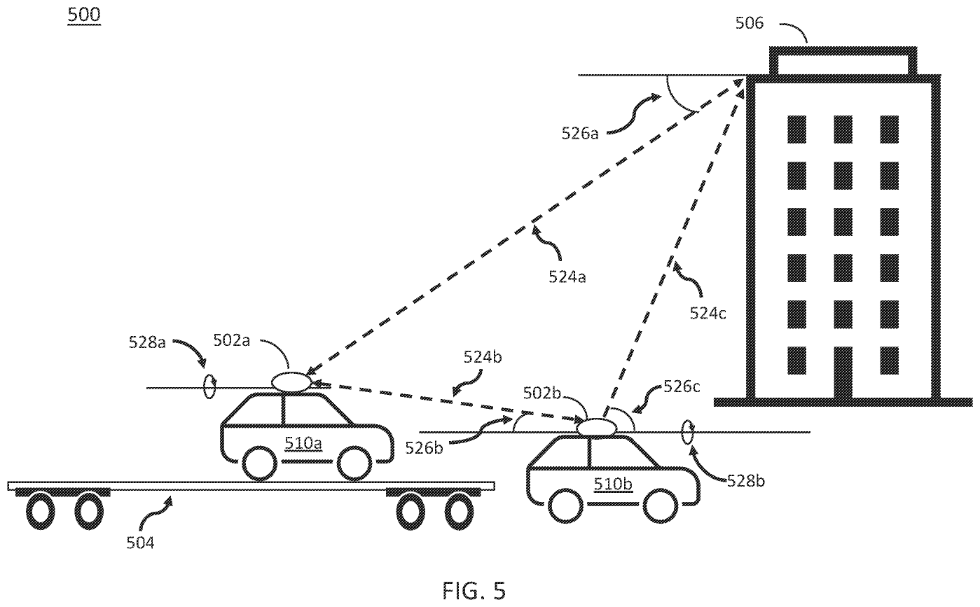

FIG. 5 is a diagram illustrating an autonomous vehicle 510a on a flatbed truck for sensor calibration during transport, according to various embodiments of the disclosure. Additionally, as shown in FIG. 5, there is a building 506 nearby and a second autonomous vehicle 510b driving on the road. The second autonomous vehicle 510b is operational and thus the sensors in the sensor suite 502b of the second autonomous vehicle are fully calibrated. According to various implementations, sensors in the first autonomous vehicle 510a can be calibrated using the building 506 as described above with respect to FIG. 3, using the distance 524a between the sensor suite 502a and a location on the building 506, as well as associated angles (e.g., angle 526a). Similarly, sensors in the first autonomous vehicle 510a can also be calibrated using the second autonomous vehicle 512.

In particular, since the second autonomous vehicle 510b is fully calibrated, the location of the second autonomous vehicle 510b is known. Since autonomous vehicle location is known to centimeter-level accuracy, as described above, the location of the second autonomous vehicle 510b sensor suite 502b is also known to centimeter-level accuracy. Thus, the distance between the second autonomous vehicle 510b and the first autonomous vehicle 510a can be determined by sensors in the second autonomous vehicle 510b. That is, the known distance 524b and angle 526b can be determined by the second autonomous vehicle 510b. Thus, measurements from first sensors in the first autonomous vehicle 510a can be compared with measurements from second sensors in the second autonomous vehicle 510b to determine accuracy of the first sensor measurements. The first sensors can be calibrated based on the comparison with the second sensor measurements.

According to various implementations, calibrations for some sensors can includes calibrations in space as a vector of x, y, and z with a fourth dimension w of roll. For example, IMU calibrations can include roll since an IMU can measure roll. In one example, the roll 528b of the calibrated vehicle 510b can be measured with respect to the building 506, and this measurement can be used to calibrate the roll 528a of the uncalibrated vehicle 510a. While FIG. 5 shows the roll 528a and the roll 528b along a single axis, in various examples, a sensor can be oriented along any axis in space. In various examples, quaternions are used to calibrate one or more sensors in a four dimensional vector space. In particular, quaternions can be used to determine three dimensional orientation of sensors.

### Example of Autonomous Vehicle Fleet

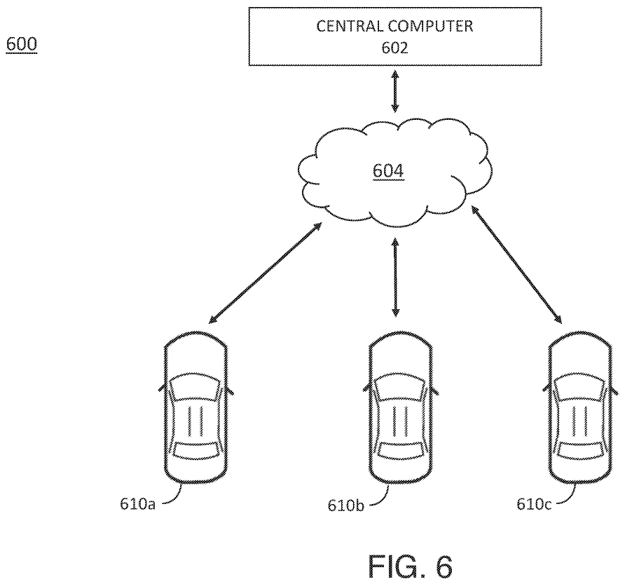

FIG. 6 is a diagram illustrating a fleet of autonomous vehicles 610a-610c in communication with a central computer 602, according to some embodiments of the disclosure. As shown in FIG. 6, the vehicles 610a-610c communicate wirelessly with a cloud 604 and a central computer 602. The central computer 602 includes a routing coordinator and a database of information from the vehicles 610a-610c in the fleet. Autonomous vehicle fleet routing refers to the routing of multiple vehicles in a fleet. In some implementations, autonomous vehicles communicate directly with each other. The vehicles 610a-610c are configured to perform extrinsic sensor calibration during transport as described above with respect to FIGS. 2-5. In some examples, one or more of the vehicles 610a-610c is being transported on an open-bed hauler, and communicates calibration information with the cloud 604 and the central computer 602.

Each vehicle 610a-610c in the fleet of vehicles communicates with a routing coordinator. In some examples, the vehicles 610a-610c send information to the routing coordinator such as sensor calibration data. In various examples, calibration data includes periodic sensor self-checks. In some examples, the calibration data includes an alert of an uncalibrated sensor, and the central computer 602 arranges for the vehicle 610a-610c with the uncalibrated sensor to be picked up by an open-bed hauler for extrinsic calibration. In particular, in some examples, the open-bed hauler drives the vehicle along a selected route and/or corridor, the vehicle 610a-610c calibrates its sensors while on the open-bed hauler, and then the vehicle 610a-610c returns to operational activity.

In various examples, information gathered by various autonomous vehicles 610a-610c in the fleet can be communicated with the routing coordinator, where it is saved and used to generate information for future routing determinations. For example, sensor data can be used to generate route determination parameters. Additionally, sensor data can be used to update mapped features for calibration and/or to generate selected calibration routes. In general, the information collected from the vehicles 610a-610c in the fleet can be used for route generation or to modify existing routes. In some examples, the routing coordinator collects and processes position data from multiple autonomous vehicles in real-time to avoid traffic and generate a fastest-time route for each autonomous vehicle. Similarly, the data can be used to generate calibration routes for open-bed haulers that avoid traffic. In some implementations, the routing coordinator uses collected position data to generate a best route for an autonomous vehicle in view of one or more travelling preferences and/or routing goals. Data can also be used to avoid various road hazards, such as potholes and speed bumps, as well as areas with high likelihood of an impact event.

According to various implementations, a set of parameters can be established that determine which metrics are considered (and to what extent) in determining routes or route modifications. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, a purpose of the route plan (e.g., passenger transport, package delivery, calibration) and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints. In another example, a routing goal includes minimizing power expenditure and conserving charge on the HV battery of the vehicle.

Routing goals may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

Some examples of routing goals include goals involving trip duration (either per trip, or average trip duration across some set of vehicles and/or times), physics, laws, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridesharing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, passenger safety, pedestrian safety, toll cost, etc. In examples where vehicle demand is important, routing goals may include attempting to address or meet vehicle demand. Additionally, routing goals can include passing a mapped feature that can be used as a calibration target, in order to check vehicle sensor calibration. In some examples, the routing coordinator determines a route for an open-bed hauler that transports an autonomous vehicle. The open-bed hauler can be an autonomous vehicle, or, the open-bed hauler may be a manually operated vehicle that follows a generated route.

Routing goals may be combined in any manner to form composite routing goals; for example, a composite routing goal may attempt to optimize a performance metric that takes as input trip duration, rideshare revenue, and energy usage and also, optimize a comfort metric. The components or inputs of a composite routing goal may be weighted differently and based on one or more routing coordinator directives and/or passenger preferences.

Likewise, routing goals may be prioritized or weighted in any manner. For example, a set of routing goals may be prioritized in one environment, while another set may be prioritized in a second environment. As a second example, a set of routing goals may be prioritized until the set reaches threshold values, after which point a second set of routing goals takes priority. Routing goals and routing goal priorities may be set by any suitable source (e.g., an autonomous vehicle routing platform, an autonomous vehicle passenger).

The routing coordinator uses maps to select an autonomous vehicle from the fleet to fulfill a ride request. In some implementations, the routing coordinator sends the selected autonomous vehicle the ride request details, including pick-up location and destination location, and an onboard computer on the selected autonomous vehicle generates a route and navigates to the destination and/or any intermediate stop.

In some implementations, each vehicle 610a-610c provides an indication of sensor calibration status to the central computing system 602. The central computing system 602 may include one or more calibration data databases to store calibration data for each vehicle 610a-610c. The calibration data databases may be communicatively coupled to the central computing system 602 and the calibration data databases may be stored on one or more servers and/or other memory devices. The calibration data databases may store data related to calibration of various sensors on each vehicle, including a date of the last full calibration of each sensor, the type and location of calibration, calibration coefficients, and a date of the last sensor calibration check.

In various implementations, the central computing system 602 determines power requirements for various routes, and state of charge of the battery in each vehicle 610a-610c is considered in selecting a vehicle to fulfill a route request. Furthermore, the central computing system 602 can predict when a vehicle 610a-610c state of charge will reach a low level, and determine when the vehicle 610a-610c will be routed to a charging center. In some examples, sensor calibrations are checked en route to a charging center and/or following autonomous vehicle charging.

In some implementations, the central computing system 602 stores additional battery-related information for each vehicle in the battery databases. For example, the battery databases may include data regarding, battery age for batteries in each of the vehicles, cost of battery replacement for each of the batteries, effects on hardware of each of the vehicles, hardware arrangements of the vehicles (such as sensors of the vehicles, control systems of the vehicles, and/or software implemented on the vehicles), or some combination thereof. The central computing system 602 may utilize the vehicle-specific information to determine vehicle-specific current draw from the battery and/or the cost of replacing the battery.

The central computing system 602 calibration database may further include data related to environmental factors for the routing assignments, since environmental factors can affect calibration status checks. The data related to the environmental factors may include environmental data (such as temperature, wind, and/or rain) and route data (such as grades of the terrain) for the routing assignments. In some embodiments, the calibration databases may further include data indicating the effects of the environmental factors calibration status. The central computing system 602 utilizes the data related to the environmental factors to evaluate accuracy of calibration checks and determine optimal times for calibration.

In some implementations, the central computing system 602 receives indications of battery states for the batteries of the vehicles in the fleet. The central computing system 602 can generate or update one or more state-of-charge profiles for each of the batteries based on a determined degradation level and the data from the battery databases. Each state-of-charge profile of the state-of-charge profiles may include an upper bound value that indicates a maximum optimal charge for the battery and a lower bound value that indicates a minimum optimal charge for the battery. Each state of charge profile also includes a low threshold state of charge for triggering an automatic shut down event.

In some implementations, the central computing system 602 flags an uncalibrated and/or damaged sensor for a vehicle and sends instructions to the vehicle to drive to a service center for repair.

In some implementations, the central computing system 602 determines characteristics for the routing assignments. For example, the characteristics may include the predicted amounts of energy for the routing assignments, the anticipated charging frequency for each vehicle, the charge-times for each vehicle, the amount of time each vehicle will be on the road, and/or the rate of charging available. Based on the characteristics, the central computing system 602 selects vehicles from the available vehicles that satisfy the characteristics of the routing assignments.

### Example of a Computing System for Ride Requests

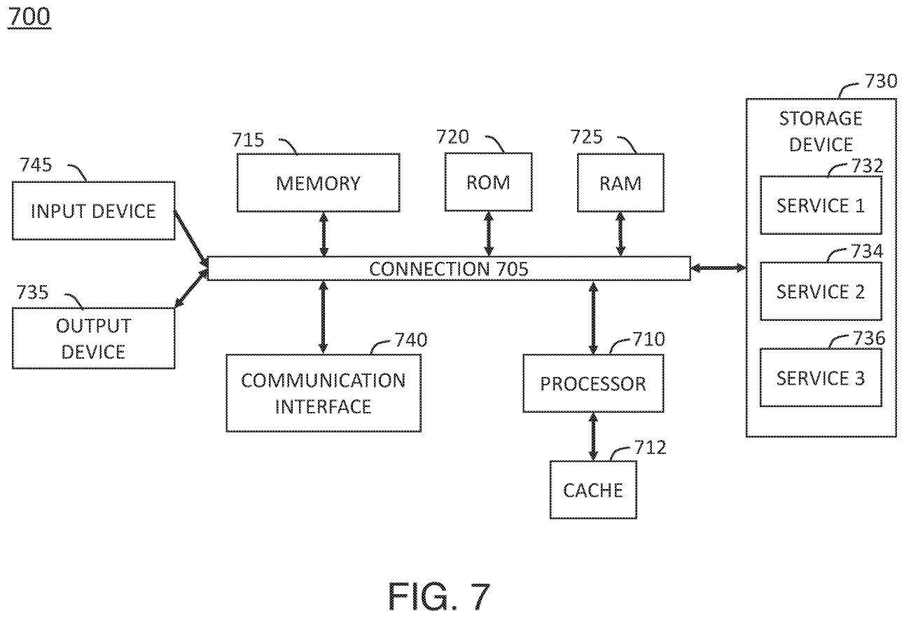

FIG. 7 shows an example embodiment of a computing system 700 for implementing certain aspects of the present technology. In various examples, the computing system 700 can be any computing device making up the onboard computer 104, the central computing system 602, or any other computing system described herein. The computing system 700 can include any component of a computing system described herein which the components of the system are in communication with each other using connection 705. The connection 705 can be a physical connection via a bus, or a direct connection into processor 710, such as in a chipset architecture. The connection 705 can also be a virtual connection, networked connection, or logical connection.

In some implementations, the computing system 700 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

The example system 700 includes at least one processing unit (CPU or processor) 710 and a connection 705 that couples various system components including system memory 715, such as read-only memory (ROM) 720 and random access memory (RAM) 725 to processor 710. The computing system 700 can include a cache of high-speed memory 712 connected directly with, in close proximity to, or integrated as part of the processor 710.

The processor 710 can include any general-purpose processor and a hardware service or software service, such as services 732, 734, and 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction, the computing system 700 includes an input device 745, which can represent any number of input mechanisms, such as a microphone for speech, a touch-sensitive screen for gesture or graphical input, keyboard, mouse, motion input, speech, etc. The computing system 700 can also include an output device 735, which can be one or more of a number of output mechanisms known to those of skill in the art. In some instances, multimodal systems can enable a user to provide multiple types of input/output to communicate with the computing system 700. The computing system 700 can include a communications interface 740, which can generally govern and manage the user input and system output. There is no restriction on operating on any particular hardware arrangement, and therefore the basic features here may easily be substituted for improved hardware or firmware arrangements as they are developed.

A storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as a processor 710, a connection 705, an output device 735, etc., to carry out the function.

As discussed above, each vehicle in a fleet of vehicles communicates with a routing coordinator. When a vehicle is flagged for service, the routing coordinator schedules the vehicle for service and routes the vehicle to the service center. When the vehicle is flagged for maintenance, a level of importance or immediacy of the service can be included. As such, service with a low level of immediacy will be scheduled at a convenient time for the vehicle and for the fleet of vehicles to minimize vehicle downtime and to minimize the number of vehicles removed from service at any given time. In some examples, the service is performed as part of a regularly-scheduled service. Service with a high level of immediacy may require removing vehicles from service despite an active need for the vehicles.

Routing goals may be specific or general in terms of both the vehicles they are applied to and over what timeframe they are applied. As an example of routing goal specificity in vehicles, a routing goal may apply only to a specific vehicle, or to all vehicles of a specific type, etc. Routing goal timeframe may affect both when the goal is applied (e.g., urgency of the goal, or, some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

In various implementations, the routing coordinator is a remote server or a distributed computing system connected to the autonomous vehicles via an internet connection. In some implementations, the routing coordinator is any suitable computing system. In some examples, the routing coordinator is a collection of autonomous vehicle computers working as a distributed system.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### Select Examples

Example 1 provides a method for calibrating vehicle sensors during transport, comprising: determining, during transport of a vehicle having a vehicle sensor on an open-bed hauler, a known distance between the vehicle sensor and a mapped target; measuring, using the vehicle sensor, a measured distance between the vehicle sensor and the mapped target; comparing the measured distance to the known distance to generate a distance comparison; and calibrating the vehicle sensor based on the distance comparison.

Example 2 provides a method according to one or more of the preceding and/or following examples, further comprising communicating calibration status with a central computing system.

Example 3 provides a method according to one or more of the preceding and/or following examples, further comprising determining a vehicle sensor location using vehicle GPS.

Example 4 provides a method according to one or more of the preceding and/or following examples, wherein determining the known distance comprises using a mapped target location and the vehicle sensor location.

Example 5 provides a method according to one or more of the preceding and/or following examples, further comprising determining a known angle between the vehicle sensor and the mapped target; and measuring, using the vehicle sensor, a measured angle between the vehicle sensor and the mapped target.

Example 6 provides a method according to one or more of the preceding and/or following examples, further comprising comparing the measured angle to the known angle to generate an angle comparison, and calibrating the vehicle sensor based on the angle comparison.

Example 7 provides a method according to one or more of the preceding and/or following examples, wherein placing the vehicle on the open-bed hauler for transport comprises placing the vehicle on one of a flatbed truck and a flatbed train carriage.

Example 8 provides a method according to one or more of the preceding and/or following examples, wherein the mapped target is one of a building, a billboard, a road sign, a street light, and a traffic light.

Example 9 provides a system for autonomous vehicle sensor calibration during transport, comprising: an open-bed hauler for carrying an autonomous vehicle; an autonomous vehicle comprising: a sensor system including at least one vehicle sensor; a memory storing a map including mapped features and mapped feature locations; and a processor configured to: determine, during transport, a known distance between the at least one vehicle sensor and a mapped feature; measure, using the at least one vehicle sensor, a measured distance between the at least one vehicle sensor at the mapped feature; compare the measured distance to the known distance to generate a distance comparison; and calibrate the at least one vehicle sensor based on the distance comparison.

Example 10 provides a system according to one or more of the preceding and/or following examples, wherein the autonomous vehicle includes a GPS system configured to determine a vehicle sensor location for the at least one vehicle sensor.

Example 11 provides a system according to one or more of the preceding and/or following examples, wherein the processor is further configured to determine the known distance using a mapped feature location and the vehicle sensor location.

Example 12 provides a system according to one or more of the preceding and/or following examples, wherein the processor is further configured to: determine a known angle between the vehicle sensor and the mapped feature; and measure, using the vehicle sensor, a measured angle between the vehicle sensor and the mapped feature.

Example 13 provides a system according to one or more of the preceding and/or following examples, wherein the processor is further configured to compare the measured angle to the known angle to generate an angle comparison, and calibrate the vehicle sensor based on the angle comparison.

Example 14 provides a system according to one or more of the preceding and/or following examples, wherein the open-bed hauler is one of a flatbed truck and a flatbed train carriage.

Example 15 provides a system according to one or more of the preceding and/or following examples, wherein the mapped feature is one of a building, a billboard, a road sign, a street light, and a traffic light.

Example 16 provides a system according to one or more of the preceding and/or following examples, further comprising a central computing system, and wherein the processor is further configured to communicate calibration status with the central computing system.

Example 17 provides a system for autonomous vehicle sensor calibration during transport, comprising: an open-bed hauler for carrying an autonomous vehicle; a central computing system comprising: a memory configured to store a map including mapped features and mapped feature locations; and an autonomous vehicle comprising: a sensor system including a vehicle sensor; a processor configured to: communicate with the central computing system to receive mapped feature locations; determine, during transport, a known distance between the at least one vehicle sensor and a respective mapped feature location; measure, using the at least one vehicle sensor, a measured distance between the at least one vehicle sensor at the mapped feature location; compare the measured distance to the known distance to generate a distance comparison; and calibrate the at least one vehicle sensor based on the distance comparison.

Example 18 provides a system according to one or more of the preceding and/or following examples, wherein the processor is further configured to communicate a calibration status with the central computing system.

Example 19 provides a system according to one or more of the preceding and/or following examples, wherein the autonomous vehicle includes a global positioning system (GPS) configured to determine a vehicle sensor location for the vehicle sensor.

Example 20 provides a system according to one or more of the preceding and/or following examples, wherein the autonomous vehicle includes a global positioning system (GPS) configured to determine an autonomous vehicle location, and wherein a vehicle sensor location for the vehicle sensor is determined based on the autonomous vehicle location.

Example 21 provides a system according to one or more of the preceding and/or following examples, wherein the autonomous vehicle includes an inertial measurement unit (IMU) configured to determine an autonomous vehicle location.

Example 22 provides a system according to one or more of the preceding and/or following examples, wherein the open-bed hauler is one of a flatbed truck and a flatbed train carriage.

Example 23 provides a method according to one or more of the preceding and/or following examples, further comprising placing a vehicle having a vehicle sensor on an open-bed hauler for transport;.

### Variations and Implementations

According to various examples, driving behavior includes any information relating to how an autonomous vehicle drives. For example, driving behavior includes how and when the autonomous vehicle actuates its brakes and its accelerator, and how it steers. In particular, the autonomous vehicle is given a set of instructions (e.g., a route or plan), and the driving behavior determines how the set of instructions is implemented to drive the car to and from various destinations, and, potentially, to stop for passengers or items. Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, “legal ambiguity” conduct (e.g., in a solid-green left turn situation, whether a vehicle pulls out into the intersection or waits at the intersection line), action profiles (e.g., how a vehicle turns, changes lanes, or performs a driving maneuver), and action frequency constraints (e.g., how often a vehicle changes lanes). Additionally, driving behavior includes information relating to whether the autonomous vehicle drives and/or parks.

As will be appreciated by one skilled in the art, aspects of the present disclosure, in particular aspects of a perception system for an autonomous vehicle, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A method for calibrating vehicle sensors during transport, comprising:
determining, during transport of a vehicle having a vehicle sensor on an open-bed hauler, a known distance between the vehicle sensor and a mapped target;
measuring, using the vehicle sensor, a measured distance between the vehicle sensor and the mapped target;
comparing the measured distance to the known distance to generate a distance comparison; and
calibrating the vehicle sensor based on the distance comparison.

2. The method of claim 1, further comprising communicating calibration status with a central computing system.

3. The method of claim 1, further comprising determining a vehicle sensor location using vehicle GPS.

4. The method of claim 3, wherein determining the known distance comprises using a mapped target location and the vehicle sensor location.

5. The method of claim 1, further comprising:
determining a known angle between the vehicle sensor and the mapped target; and
measuring, using the vehicle sensor, a measured angle between the vehicle sensor and the mapped target.

6. The method of claim 5, further comprising comparing the measured angle to the known angle to generate an angle comparison, and calibrating the vehicle sensor based on the angle comparison.

7. The method of claim 1, wherein placing the vehicle on the open-bed hauler for transport comprises placing the vehicle on one of a flatbed truck and a flatbed train carriage.

8. The method of claim 1, wherein the mapped target is one of a building, a billboard, a road sign, a street light, and a traffic light.

9. A system for autonomous vehicle sensor calibration during transport, comprising:
an open-bed hauler for carrying an autonomous vehicle;
an autonomous vehicle comprising:
a sensor system including at least one vehicle sensor;
a memory configured to store a map including mapped features and mapped feature locations; and
a processor configured to:
determine, during transport, a known distance between the at least one vehicle sensor and a mapped feature;
measure, using the at least one vehicle sensor, a measured distance between the at least one vehicle sensor at the mapped feature;
compare the measured distance to the known distance to generate a distance comparison; and
calibrate the at least one vehicle sensor based on the distance comparison.

10. The system of claim 9, wherein the autonomous vehicle includes a global positioning system (GPS) configured to determine a vehicle sensor location for the at least one vehicle sensor.

11. The system of claim 10, wherein the processor is further configured to determine the known distance using a mapped feature location and the vehicle sensor location.

12. The system of claim 9, wherein the processor is further configured to:
determine a known angle between the vehicle sensor and the mapped feature; and
measure, using the vehicle sensor, a measured angle between the vehicle sensor and the mapped feature.

13. The system of claim 12, wherein the processor is further configured to compare the measured angle to the known angle to generate an angle comparison, and calibrate the vehicle sensor based on the angle comparison.

14. The system of claim 9, wherein the open-bed hauler is one of a flatbed truck and a flatbed train carriage.

15. The system of claim 9, wherein the mapped feature is one of a building, a billboard, a road sign, a street light, and a traffic light.

16. The system of claim 9, further comprising a central computing system, and wherein the processor is further configured to communicate calibration status with the central computing system.

17. A system for autonomous vehicle sensor calibration during transport, comprising:
an open-bed hauler for carrying an autonomous vehicle;
a central computing system comprising:
a memory configured to store a map including mapped features and mapped feature locations; and
an autonomous vehicle comprising:
a sensor system including a vehicle sensor;
a processor configured to:
communicate with the central computing system to receive mapped feature locations;
determine, during transport, a known distance between the at least one vehicle sensor and a respective mapped feature location;
measure, using the at least one vehicle sensor, a measured distance between the at least one vehicle sensor at the mapped feature location;
compare the measured distance to the known distance to generate a distance comparison; and
calibrate the at least one vehicle sensor based on the distance comparison.

18. The system of claim 17, wherein the processor is further configured to communicate a calibration status with the central computing system.

19. The system of claim 17, wherein the autonomous vehicle includes a global positioning system (GPS) configured to determine a vehicle sensor location for the vehicle sensor.

20. The system of claim 17, wherein the open-bed hauler is one of a flatbed truck and a flatbed train carriage.
